(19) United States
(12) Patent Application Publication
(10) Pub. No.: US 2008/0238709 A1
(43) Pub. Date: Oct. 2, 2008

(54) One-way communication apparatus with dynamic key generation

(76) Inventors: Faramarz Vaziri, Hopewell Junction, NY (US); Andrew Pletch, New Paltz, NY (US); Mehrdad Jamei Nadooshan, New York, NY (US)

Correspondence Address: Billy J. Knowles;BK Patents, Inc., 72 Hurley Av., Kingston, NY, 12401, US

(21) Appl. No.: 12/079,199

(22) Filed: Mar. 25, 2008

Related U.S. Application Data
(60) Provisional application No. 60/908,507, filed on Mar. 28, 2007.

(51) Int. Cl. G05B 19/04; G06F 7/04

(52) U.S. Cl. 340/825.22; 340/5.2

(57) ABSTRACT

A remote control device is coupled with a computing device such as a set top computing device using wired or wireless connectivity for the purpose of invoking services provided by the computing device. The remote control device uses biometric methods such as fingerprint scanning to identify the user of the remote control device who is also a previously authorized user of the computing device. The remote control device possesses a unique identifying serial number. Identity of the user of the remote control device is communicated to the computing device and used by the computing device to authenticate the remote control device user as a previously authorized user of both devices. Once a remote control user is authenticated, all signals from the remote control device to the set top computing device are encrypted in such a way as to prevent impersonation using a similar remote control device or man-in-the-middle attacks.

This application claims priority under 35 U.S.C. §119 to U.S. Provisional Patent Application Ser. No. 60/908,507, filed on Mar. 28, 2007, which is herein incorporated by reference in its entirety.

### BACKGROUND OF THE INVENTION

1. Field of the Invention

This invention relates to remote control devices such as those commonly used to control televisions and slave computing devices. More particularly, the present invention relates to remote control devices having one-way communication with a set top computing device and providing user authentication.

2. Description of Related Art

Hand-held infrared and radio frequency remote control devices are commonly used to remotely control appliances such as television receivers, compact disc players, and other electronic devices. Such remote control devices can also be used to control set-top-boxes which are, in part, menu-driven computer devices and which use the television as a computer monitor. Computers, by-and-large, require user authentication before executing user commands. A limitation of prior art infrared remote control devices is that there is no convenient way to specify who the current user is, and based on the user's identity, to control or limit the operation of the appliance. In U.S. Patent Application 2004/148,632 (Park et al.) describe a remote control device for use with a set-top-box that enhances user mobility, convenience and functionality but does not provide for use by only authorized users and secure communication of the remote control device to the set-top-box.

A further limitation of prior art infrared remote control devices, including those which are biometric characteristic-enabled, is that they do not have the electronic means of distinguishing signals as coming from one such device or from another similar remote control device. In U.S. Patent Application 2003172,283 (O'Hara) describes a biometric characteristic-enabled remote control device that identifies the user of the device but does not provide for secure communication between the device and the slave controlled by the device. Therefore traditional remote control devices, including those which are biometric characteristic-enabled, are not appropriate as input devices for a computing device. This is particularly relevant since infrared readers and transmitters are readily available and inexpensive as of the date of this application so that mounting a man-in-the-middle attack on infrared transmissions is no longer a possibility for just a few, very highly skilled people.

With current remote control devices, even those which are biometric characteristic-enabled, it is possible to use a similar device and impersonate someone else supposedly using a different device. For example, a small key fob called “TV-B-Gone” is available for people who want to turn off the television in a public place such as a bar or restaurant.

U.S. Pat. No. 6,401,205 (Rallis, et al) describes an infrared type security system for a computer.

U.S. Pat. No. 6,871,230 (Fukunaga, et al) describes a system and method of personal identification.

U.S. Pat. No. 6,910,132 (Bhattacharya) describes a secure system and method for accessing files in computers using fingerprints.

RFC 3174 “US Secure Hash Algorithm 1 (SHA1)” (Eastlake et al.), found http://tools.ietf.org/html/rfc3174, Sep. 25, 2006, specifies a Secure Hash Algorithm, SHA-1, for computing a condensed representation of a message or a data file. When a message of any length <2⁶⁴ bits is input, the SHA-1 produces a 160-bit output called a message digest. The message digest can then, for example, be input to a signature algorithm which generates or verifies the signature for the message.

RFC 1321 “The MD5 Message-Digest Algorithm” Rivest, April 1992, found http://tools.ietf.org/html/rfc1321, Sep. 25, 2006, describes message-digest algorithm that takes as input a message of arbitrary length and produces as output a 128-bit “fingerprint” or “message digest” of the input. It is conjectured that it is computationally infeasible to produce two messages having the same message digest, or to produce any message having a given pre-specified target message digest.

### SUMMARY OF THE INVENTION

An object of this invention is to provide authenticated remote control of a slave computing device.

Another object of this invention is to provide an encrypted command message over a one-way communication channel to control a slave computing device.

Another object of this invention is to provide verification that a user is authorized to use the remote control with a user authentication device such as a fingerprint reader, a face recognition device, a voice recognition device, or any other biometric device.

To accomplish at least one of these objects, a one-way communication system communicates from a one-way communication apparatus such as remote control device to a slave computing system. The one-way communication device transfers authenticated command messages from the remote location for invoking services provided by the slave computing device.

The one-way communication system has a one-way communication apparatus such as a remote control device and receiving device in communication with the slave computing device. The one-way communication apparatus has a shared secret data retention device to retain a shared identifying cipher associated uniquely with the one-way communication apparatus. The shared identifying cipher is known only by and retained by both the one-way communication apparatus and the slave computing device. A dynamic key generation device generates a dynamic non-reusable key which combined with the shared identifying cipher for encrypting the command instruction code. A user authentication device is connected to receive a current user identification data for generating a user verification code that the user is authorized to use the one-way communication device to communicate with the slave computing device.

The one-way communication device has an encryption device connected to receive the command instruction code that indicates a service to be invoked on the slave computing system. The encryption device is connected to the shared secret retention device to extract the shared identifying cipher and the dynamic key generation device to receive the dynamic non-reusable key. The shared secret cipher is formed of a serial number assigned to the one-way communication apparatus and a personal identification number identifying an authorized user of the slave computing system.

The user authentication device transfers the user verification code to the encryption device and if the user verification code indicates that the user is a known user of the one-way communication apparatus, the encryption device encrypts the command instruction code, the shared identifying cipher, and the dynamic non-reusable key together to form an authenticated command message using a message digest algorithm or a secure hash algorithm. The command instruction code is coupled with the authenticated command message and transmitted to the slave computing system to invoke the services provided by the slave computing device.

The receiving device is in communication with the slave computing device and the one-way communication apparatus for receiving a transmission message that includes the authenticated command message. The receiving device decrypts the authenticated command message to develop a command invocation code that is transferred to the slave computing device to invoke the services provided by the slave computing device.

The one-way communication apparatus further includes a first memory device retaining an original user identification data captured during a registration of the user on the one-way communication apparatus. The user authentication device receives the current user identification data and extracts the original user identification data from the first memory device for comparing the current user identification data and the original user identification data for verifying the user identification and generating the verification code.

The one-way communication apparatus further includes a key pad and a command interpretation device. The key pad has an arrangement of key switches such that when any of the key switches are activated, the key pad generates a key code. The command interpretation device receives the key code from the key pad and generates the command instruction code for invoking services provided by the slave computing device.

The dynamic non-reusable key is formed a monotonically increasing key code and a dynamically generated key. The dynamic key generation device includes a monotonically increasing number generator and a dynamic key calculating device. The monotonically increasing number generator creates the monotonically increasing key code. The dynamic key calculating device is connected to the user authentication device to receive a unique error as a function of the current user identification data. From the unique error, the dynamic key calculating device generates the dynamically generated key.

Alternately, the dynamic non-reusable key is a timestamp code indicating an initiation time for a session of a plurality of authenticated command messages. The one-way communication apparatus further includes a timer device that generates the timestamp code and is in communication with the encryption device to transfer the timestamp code to the encryption device as the dynamic non-reusable key.

The one-way communication apparatus further includes a protocol construction device and a transmitter. The protocol construction device is in communication with the encryption device to receive the authenticated command message and appends a synchronization signal and error code to the authenticated command message to generate the transmission message. The transmitter transmits the transmission message to the slave computing system to invoke the services provided by the slave computing device.

The one-way communication apparatus registers a user as an authorized user of the one-way communication apparatus by first placing the serial number permanently in the shared secret data retention device by a manufacturer. A register command is transferred to the encryption device. The slave computing system communicates a user identification number. The user then communicates the user identification number to the encryption device through the key pad. The encryption device then encrypts the user identification number with the serial number to generate an encrypted user code which is then transmitted to the slave computing system. The slave computing system then requests the personal identification number from the user. The user then communicates the personal identification number through the key pad to the encryption device and the shared secret data retention device. The encryption device then encrypts the personal identification number with the serial number to generate an encrypted shared identifying cipher that is then transferred to the to the slave computing system for verification. If the encrypted shared identifying cipher is verified, the user communicates an original user identification data that is compared with the current user identification data to generate user verification code. An approval code is then encrypted with the shared identifying cipher to generate an encrypted approval code and transferred to the slave computing system. The user is then registered as authorized to use the one-way communication apparatus to invoke the services provided by the slave computing device.

The user invokes the services provided by the slave computing device by first providing a user identification number and generating the current user identification data. The currently generated user identification data is compared with the original user identification data to verify that the user is authorized to use the one-way communication apparatus. The dynamic non-reusable key is encrypted with the shared identifying cipher to generate a dynamic non-reusable key code and communicated to the slave computing system. The user keys a key on the keypad which is interpreted as the command instruction code. The command instruction code is encrypted with shared identifying cipher and the dynamic non-reusable key to generate the authenticated command message, which is then communicated to the slave computing device. The receiving device then decrypts the authenticated command message extract the command instruction code for transfer to the slave computing device. The slave computing device then invokes the services provided and authorized by the slave computing device. The invoked services of the slave computing are for example voice and video telephone services, voice and video conferencing services, email services, and computing functional services of the slave computing device.

The receiving device includes a reception device for acquiring and conditioning the transmission message. A protocol extraction device is in communication with the reception device to receive the transmission message and extract the authenticated command message. A decryption device is in communication with the protocol extraction device to receive the authenticated command message to extract the command instruction code, shared identifying cipher, and the dynamic non-reusable key. A user authentication device in communication with the decryption device to receive the command instruction code, shared identifying cipher, and the dynamic non-reusable key and compare shared identifying cipher, and the dynamic non-reusable key with a retained copy of the shared identifying cipher, and the dynamic non-reusable key to verify that the command instruction code is from an authorized user and to generate a verified user code. The receiving device further has a signal interpretation device. The signal interpretation device is in communication with the user authentication device to receive the verified user code and the command instruction code. If the verified user code indicates that the user is authorized, the signal interpretation device forwards the command instruction code to the slave computing device to invoke the invoking services provided by the slave computing device. The signal interpretation device in communication with the protocol extraction device to receive an un-encrypted command instruction code. The un-encrypted command instruction code is in turn forwarded to the slave computing system for execution, if the verified user code indicates that the user is authorized.

The slave computing device provides the user authentication device a user permission code. The user permission code determines if an authorized user is permitted to invoke the invoking services provided by the slave computing device and sets the verified user code whether the authorized user has permission for invoking the services from the slave computing device.

### BRIEF DESCRIPTION OF THE DRAWINGS

FIG. 1 shows a remote control device in one-way communication with a slave computing device connected through various networks to other electronic devices. FIG. 1 also shows the potential for a man-in-the-middle attack on the communication between the remote control device and the slave computing device.

FIG. 2a is a block diagram of a remote control device that provides secure, one-way communication with a slave device.

FIG. 2b is a block diagram of a slave computing device able to authenticate the one-way communications from a remote controlling device.

FIG. 3 is a block diagram of a remote control device capable of scanning user biometric characteristics.

FIGS. 4a and 4b is a flow chart describing the process of accepting an initial biometric characteristic scan on a biometric characteristic-enabled remote control device.

FIG. 5 is a flow chart describing the process of accepting keystrokes on a remote control device and transmitting them encrypted to a slave computing device.

FIG. 6 is a flowchart describing the process of scanning a user biometric characteristic to determine if the user is a previously authorized user of the same remote control device.

FIGS. 7a and 7b describe the one-way transmission formats for messages between a remote control device and a slave computing device.

### DETAILED DESCRIPTION OF THE INVENTION

A mechanism by which the people using a remote control device could be biometrically identified and the identification be used to securely communicate to a controlled computing device would be an improvement over existing remote control devices, even those which are biometric characteristic-enabled. This mechanism would enable the controlled computing device to authenticate each signal from a remote control device as coming from a user of the remote control device who is an authorized user of the controlled computing device.

A remote control device, possessing of a unique embedded serial number and in communication with a computer uses biometric characteristics of the remote control device's user to identify the user. The remote control device is equipped with a memory and the serial number uniquely identifying the remote control device is stored in the memory. The same serial number is stored in the memory of the computer at installation time. A remote control device is equipped with a biometric scanner or reader that is coupled to a signal processor within the remote control device and which scans or reads a user's biometric characteristic, the signal processor within the remote control device compares the scanned or measured biometric characteristic of the user against stored characteristics of authorized users of the remote control device to determine who the user is. This determination is temporary and must periodically be renewed. A remote control device is equipped with a microcontroller that is coupled to the memory of the remote control device and the signal processor.

When the microcontroller software determines that a sensed biometric characteristic matches an authorized user of the remote control device, the remote control's microcontroller and software within the remote control thereafter will send encrypted signals to the computer in response to individual key strokes on the remote control device. The signals incorporate an encryption of five arguments—a random key, the identity of the user, the identity of the remote control device and a monotonically increasing connection number—all four forming a shared secret cipher—and the identity of the keystroke. The signals permit the computer to determine that the signals come from an authorized user of the computer using a specific remote control device and that the authorized user is currently manipulating the authorized remote control device.

Various methods can be used to circumvent the security requirements as described above. The first of these methods is impersonation where someone with a similar remote control device containing the biometric characteristics of at least one person who is not an authorized user of the computing device attempts to receive services from the computing device authorized for some other person. The fact that all the encrypted signals from any remote control device use the remote control device serial number as part of the shared secret ensures that impersonation is not possible. The computer will decrypt any received signal using the appropriate serial number and determine that the signal came from an unknown remote control device.

A second kind of impersonation is where one authorized user of the remote control device tries to impersonate another authorized user of the same remote control device. Encrypting all signals while using the user PIN as part of the shared secret prevents this attack since different authorized users will be in possession of different PINs.

It is the nature of a remote control device that the distinct unencrypted signals that it transmits are very few in number, limited by the number of keys on the remote control device. Without a dynamically changing share secret, it would be possible to mount a different man-in-the-middle attack by first capturing all possible signals, encrypted or otherwise, from an authorized remote control device and then building an infrared transmitter that could impersonate an authorized user by retransmitting the captured signals. Thus the shared secret includes a key that changes each time a biometric characteristic scan is performed.

Another threat to security is also possible from a man-in-the-middle attack. In this attack a second infrared receiver receives and stores the same encrypted signals intended for the computing device. Then, at a later time, these same signals are played back and transmitted by a different infrared transmitter in an attempt to make the computer accept these signals as coming from an authorized user of an authorized remote control device. Even with a dynamically changing key this attack is possible since it is the remote control device that generates the key and the key is then transmitted to the computer. The computer needs some way of knowing that a previously used key is not being reused. Using a monotonically increasing sequence of numbers as part of the shared secret for the encrypted signals transmitted from a remote control device following a single biometric characteristic scan of an authorized user, ensures that capturing such a sequence and playing them back in the future in a man-in-the-middle attack will fail since the computer will expect an number larger than the one used in the captured sequence for any future communication between the remote control device and the computer.

Signals sent by the remote control device and received by the computer are used by the computer to authenticate the sending remote control device and the user of the sending remote control device. The signals are also used by the computer to identify the encrypted keystroke and determine what service of the computer is being requested. Provided the user of the remote control device is an authorized user of the computer and the service requested is one the user of the computing device is authorized to receive, the computer will provide the requested service. In one embodiment of the invention, a fingerprint scanner coupled to a microcontroller within the remote control device provides a biometric characteristic identification of the user of the remote control device and henceforth, using an encryption process, securely identifies all communication from the remote control device to the computer as coming from the remote control device and from the identified user. Services indicated by signals received by the computer are provided only to authenticated and authorized users of the computer. The encryption process employs a message digest process of the MD-5 algorithm as described in RFC 1321. Alternately, the encryption process could employ a shared hash algorithmic process such as described in RFC 3174.

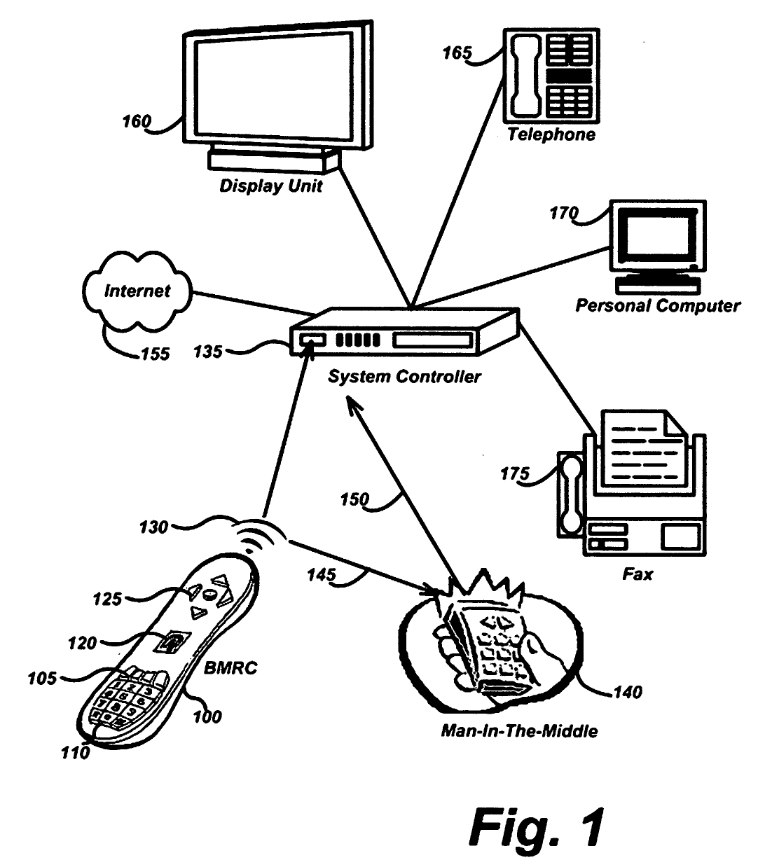

FIG. 1 shows a drawing of a one-way communicating remote control device 100. The remote control device 100 is able to capture a biometric characteristic of a user (such as a finger print) and once having verified the identity of the user thereafter transmitting in encrypted fashion all keystrokes entered at the remote control device 100 to a slave device such as a slave computing device 135; such encryption will incorporate a randomly-generated key, the identity of the physical remote control device 100 (as opposed to some other, similar remote control device 140), the identity of the user whose biometric characteristic has been scanned and validated, and the identity of the keystroke. To facilitate this, the remote control device 100 has stored in its non-volatile memory a unique serial number that was also stored in the slave computing device 135 memory at configuration time. The slave computing device 135, receiving any encrypted keystroke signal 130 after the remote control device 100 user has been authenticated, verifies that the encrypted keystroke is a keystroke from a uniquely identifiable remote control device 100 being used by a user who is an authenticated user of the slave computing device 135 and further processes the raw keystroke from the remote control device 100 accordingly. The computing device is connected through the Internet 155 and other networking technologies such as the Public Switched Telephone Network to other computers 170, telephones 165, a display unit 160 and devices such as fax machines 175.

The remote control device 100 includes a plurality of control buttons 105, a numeric keypad 110, a biometric scanner 120 and a directional pad 125. As hereinafter, the remote control device 100 uses specific control buttons 105, the numeric pad buttons 110, and the biometric scanner 120 to identify a user as an authorized user of the set top slave computing device 135. The identification is confirmed by displaying an appropriate “welcome” message on the display unit 160. Keys on the directional pad 125 are used as a rudimentary mouse in controlling the functionality of the slave computing device 135 and through the computer, using software installed on the computer, the previously mentioned devices to which it is connected.

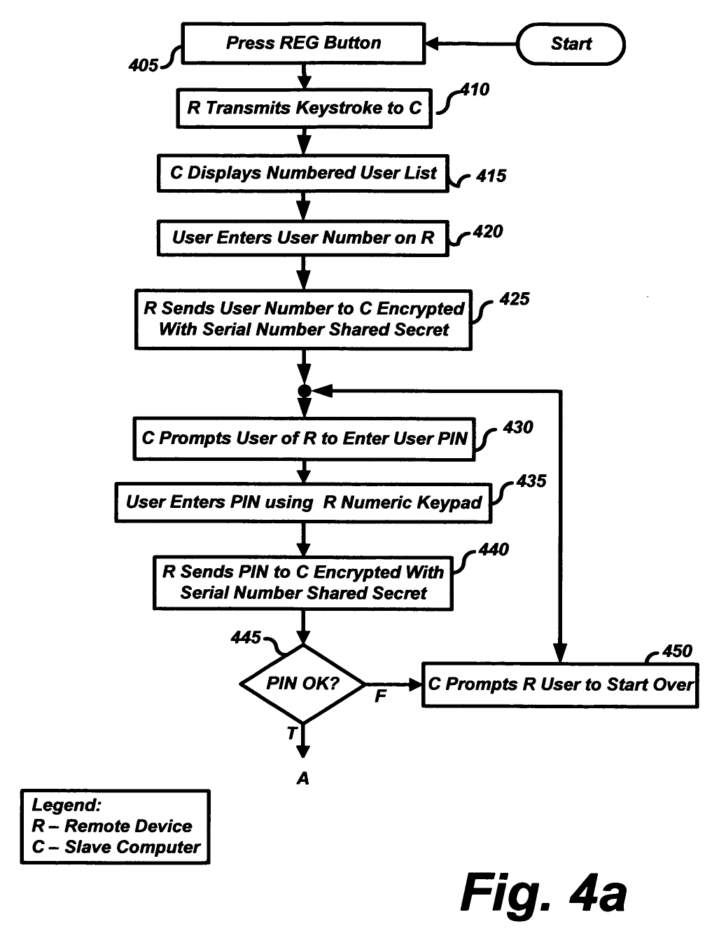

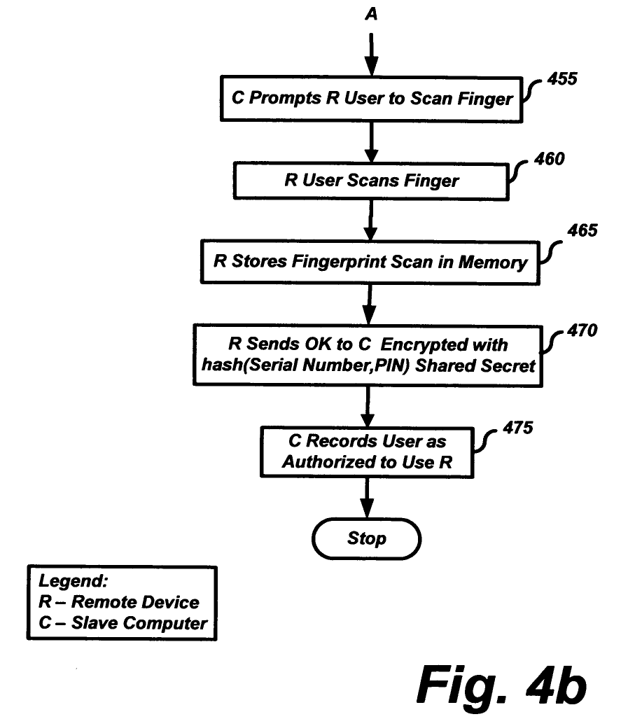

The user of the remote control device 100 must be a previously-authorized user of the slave computing device 135. To ensure this correspondence, users of the slave computing device 135 register with the slave computing device 135 through an interface such as a web interface and set a password. Each time a user password is set or changed on the slave computing device 135, the user is provided with a Personal Identification Number (PIN) that must be used in conjunction with a first scan of the remote control device 100 user's biometric characteristic (as described in FIG. 4) before the user can use the remote control device 100 to communicate with the slave computing device 135. This PIN can not be used more than once to perform a first scan of the remote control device 100 user's biometric characteristic. Future first scans require a new PIN. The first scan of the computing device 135 remote control device 100 user's biometric characteristic starts with the user pressing one of the remote control device 100 control buttons 105. The button press is communicated to the slave computing device 135 that takes over the display of the display unit 160 where it displays a numbered list of authorized users. The remote control device 100 user is prompted to enter the number that appears beside their own name using the numeric key pad 110. The keystroke is communicated by the remote control device 100 to the slave computing device 135 as well as being stored in the device's 100 non-volatile memory 320. The slave computing device 135 then prompts the user of the remote control device 100 to enter the PIN provided as part of the slave computing device 135 registration process. The PIN is entered using the remote control numeric keypad 110 and the keystrokes are communicated in encrypted fashion by the remote control device 100 to the slave computing device 135 and stored in the device's 100 non-volatile memory 320. When the valid PIN is entered, the slave computing device 135 prompts the remote control device 100 user to scan the user's biometric characteristic. Upon successful scan the remote control device 100 transmits an appropriate encrypted signal to the slave computing device 135.

Without the security measures of this invention, other devices 140 can be used to either imitate (impersonation attack) or capture and replay (man-in-the-middle attack) signals that normally pass from the remote control device 100 to the slave computing device 135.

A preferred implementation of the encryption of a remote control device 100 keystroke can be a hash function of four arguments—a random non-reusable key, the remote control device's 100 serial number and remote control device 100 user PIN which together comprise the shared secret and the keystroke itself—or a well-known algorithm such as SHA-1 or MD5 applied to these arguments.

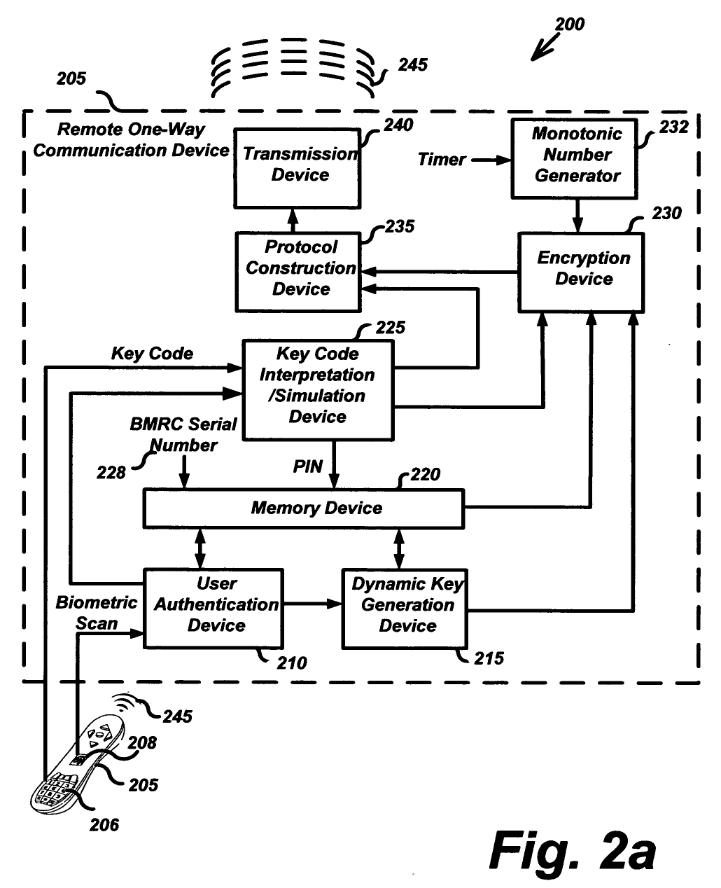

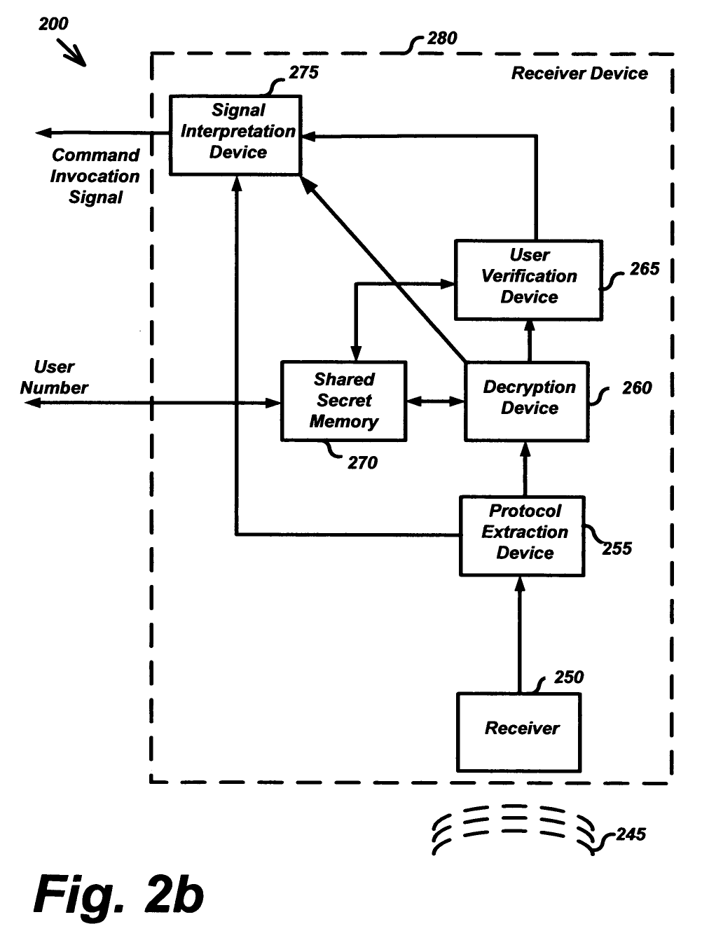

FIGS. 2a and 2b illustrate block diagram of the one-way communications system 200 of this invention. The one-way communication system 200 includes a biometric characteristic-enabled one-way communicating remote control device 205 and a receiver 280 connected to the slave computing device 135 of FIG. 1. The remote control device 205 has stored in its memory device 220 at the time of manufacture, a serial number 228 unique to that remote control device.

During the initial registration process, the user presses a registration key on the remote device keypad 206. The key code interpretation/simulation device 225 accepts this keystroke and sends it unencrypted to the protocol construction device 235. The protocol construction device 235 builds a transmission message and transmits it to the receiver 250. The receiver 250 transfers the message to the protocol extraction device that de-multiplexes the message and transfers the keystroke code directly to the signal interpretation device 275. The signal interpretation device 275 then determines that a registration is in process and informs the slave computing device 135 of FIG. 1 to display a numbered list of authorized users on the display unit 160 of FIG. 1.

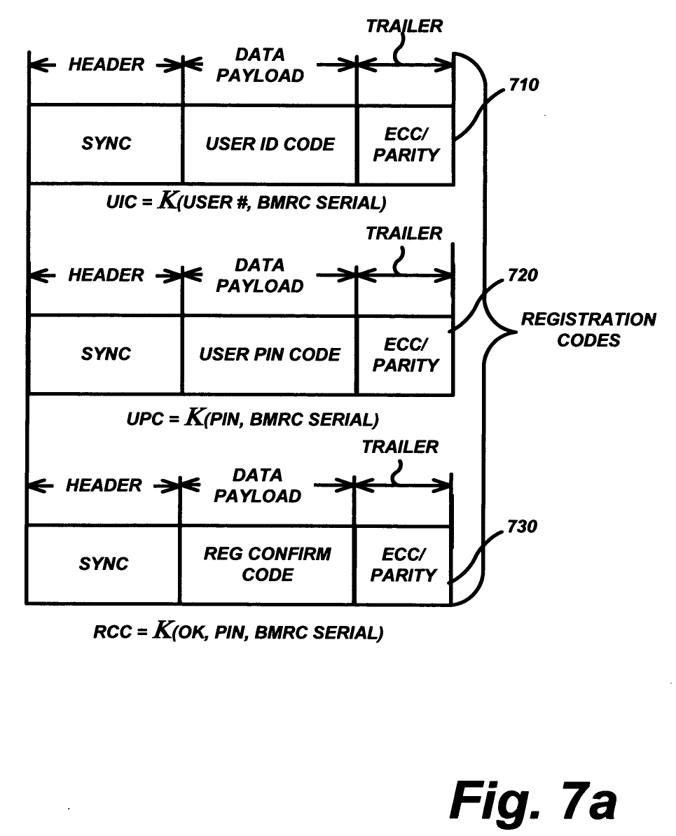

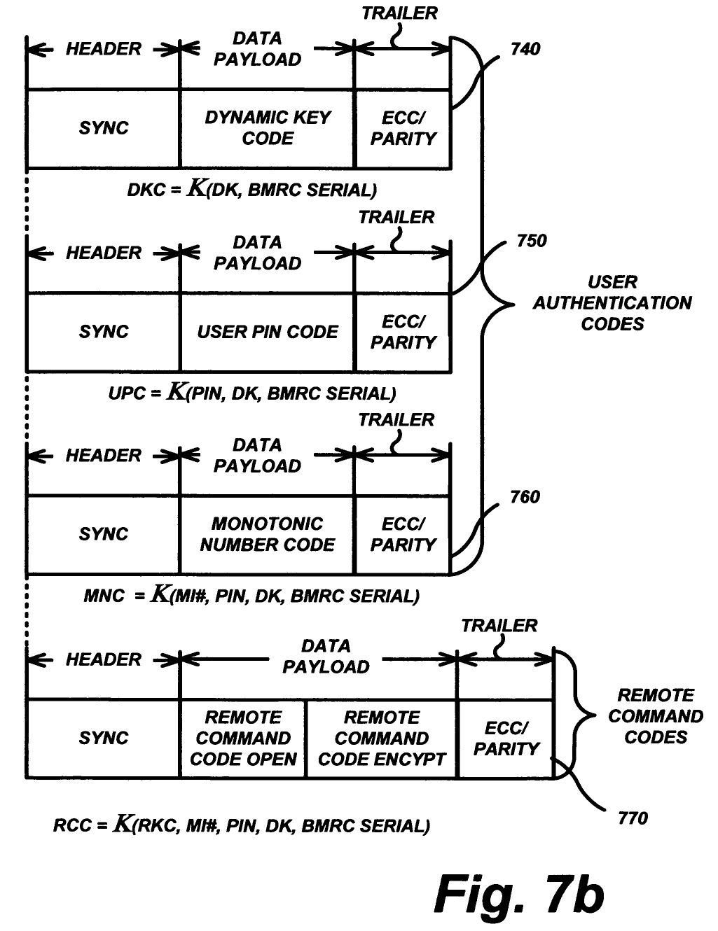

The user is then prompted using the keypad 206, to enter the number associated with the user's name on the numbered list. This number is transferred to the key code interpretation/simulation device 225 and forwarded to the encryption device 230. The encryption device 230 retrieves the remote serial number 228 from the memory device 220 and encrypts the keystroke using the serial number as the shared secret. The encrypted keystroke is transferred to the protocol construction device 235 which builds the User ID Code transmission message 710 of FIG. 7 and delivers it to the transmission device 240 for transmission. The transmitted signal is received by the receiver 250 of the receiving device 280 which, in turn, delivers it to the protocol extraction device 255. The protocol extraction device de-multiplexes the received message and delivers the payload to the decryption device 260 for decryption. The decryption device uses the same serial number (stored in its shared secret memory 270 at configuration time) to decrypt the message. The resulting user identification number is saved by the user verification device 265 for the next authentication step.

In the next step in the authentication process the slave computing device 135 displays a message that instructs the user to enter the user's PIN using the remote control device 205 keypad 206. The user enters the user's PIN and this is captured by the key code interpretation/simulation device 225. The code interpretation device 225 interprets the key code as the PIN and delivers the PIN to the encryption device which encodes it using the serial number 228 which it retrieves from the memory device 220. The encryption device 230 transfers the encrypted PIN to the protocol construction device 235 and the latter builds the User PIN Code transmission message 720 of FIG. 7 and delivers it to the transmission device 240 for transmission. The signal is received by the receiver 250 and given to the protocol extraction device 255 for de-multiplexing. The de-multiplexed User PIN Code is transferred to the decryption device which uses the serial number shared secret cipher to decrypt the PIN. The user verification device 265 then determines if the decrypted PIN matches the PIN of the user identified by the previously transmitted and received user number and if so delivers a signal to the signal interpretation device 275 that causes the slave computing device 135 to display a message on the display unit 160 telling the user to perform a biometric scan using the scan device 208.

Once this scan is performed successfully, the resulting measurement data is stored by the user authentication device 210 in the memory device 220. The user authentication device 210 then informs the key code interpretation/simulation device 225 to generate a simulated registration confirmation code and deliver it to the encryption device 230. The encryption device 230, encodes the registration confirmation code using the serial number and PIN as a shared secret cipher and delivers the encrypted signal to the protocol construction device 235. The protocol construction device 235 constructs the transmission message 730 of FIG. 7 and transfers it to the transmission device 240 for transmission. This message is received by the receiver 250 and transferred to the protocol extraction device 255 where it is de-multiplexed. The encrypted payload is transferred to the decryption device 260 where it is decrypted using the PIN and serial number shared secret ciphers retrieved from the shared secret memory 270. The confirmation code is transferred to the user verification device 265 which now records that an authorized user of the slave computing device 135 is now registered to use the remote control device as a means of sending commands to the slave computing device 135.

In the Scan process, whereby a user of the remote control device 205 performs an authenticating biometric scan prior to using the remote control device 205 to control the slave computing device 135, the user presses a Scan key on the remote device keypad 206. The key code interpretation/simulation device 225 accepts this keystroke, interprets it, and sends it unencrypted to the protocol construction device 235. The protocol construction device 235 builds a transmission message and transmits it to the receiver 250. The receiver 250 transfers the message to the protocol extraction device that de-multiplexes the message and transfers the keystroke code directly to the signal interpretation device 275. The signal interpretation device 275 then determines that a scan is in process. The signal interpretation device 275 does nothing for a period of time (for example, three seconds). Meanwhile, if the user of the remote control device 205 knows the user number used during initial registration it can be keyed in using the keypad 206 at any time. If after the period time (for example, the three seconds) no further signals have been received by the signal interpretation device 275 it sends a message to the computer that the numbered user list should be displayed, prompting the user of the remote to key in the user number beside the name on this list.

In either case, the user keys in the user number. The number is captured by the key code interpretation/simulation device 225 and saved in the memory device 220. The user then performs a biometric scan using scanner 208 and the result of the scan is transferred to the user authentication device 210. The user authentication device 210 retrieves the original scan data associated with the previously keyed in user number from the memory device 220 and compares it to the currently scanned biometric data.

If the two scans do not match within certain tolerance limits, the user authentication device 210 then informs the key code interpretation/simulation device 225 to generate a simulated failed scan code and deliver it to the protocol construction device. The protocol construction device 235 builds a transmission message and the transmission device 240 transmits it 245 to the receiver 250. The receiver 250 transfers the message to the protocol extraction device that de-multiplexes the message and transfers the keystroke code directly to the signal interpretation device 275. The signal interpretation device 275 then determines that a scan process has failed and informs the slave computing device 135 to display a message on the display unit 160 saying that the user should start the scan process again.

Once a scan process results in a successful match of initial and current biometric characteristics, the user authentication device 210 then transfers the difference (delta) between the initial biometric scan and the current scan to the dynamic key generation device 215 which uses this value as a unique error code to generate a new, random key. This key is stored in the memory device 220. This key is also transferred to the encryption device where it is combined with a monotonically increasing sequence number generated by the monotonic number generator 232. Together these are encrypted using the serial number as the shared secret cipher. The encrypted data is transferred to the protocol construction device 235 where the dynamic key code transmission message 740 of FIG. 7 is formed and transferred to the transmission device 240 for transmission 245 to the receiving device 250. The signal is received by the receiver 250 and given to the protocol extraction device 255 for de-multiplexing. The de-multiplexed encrypted dynamic key code is transferred to the decryption device 260 which uses the serial number shared secret cipher retrieved from the shared secret memory 270 to decrypt the dynamic key code. The decryption device 260 uses the monotonicity of the monotonically increasing sequence number component of the message to determine that the key has not been previously used and then stores the random key in the shared secret memory 270.

Finally, the key code interpretation/simulation device 225 delivers the PIN to the encryption device which encodes it using the serial number 228 and the newly created dynamic key, both retrieved from the memory device 220. The encryption device 230 transfers the encrypted PIN to the protocol construction device 235 and the latter builds the User PIN Code transmission message 750 of FIG. 7 and delivers it to the transmission device 240 for transmission. The signal is received by the receiver 250 and given to the protocol extraction device 255 for de-multiplexing. The de-multiplexed user PIN code is transferred to the decryption device which retrieves the serial number and random key code from the shared secret memory 270 and uses these shared secret ciphers to decrypt the PIN. The user verification device 265 then determines if the decrypted PIN matches the PIN of the user identified by the previously transmitted and received user number and if so documents it in the shared secret memory 270.

The user verification device 265 is now possessed of all three components of the shared secret cipher used to encrypt further keystroke messages sent between the remote control device 205 and the slave computing device 135—the remote serial number, the user PIN and a unique, not-previously-used dynamic random key. Any further keystrokes entered by the user using keypad 206 are received by the key code interpretation/simulation device 225 and from there transferred (unencrypted) to the protocol construction device 235 and to the encryption device 230 where the keystroke is encrypted using the shared secret ciphers serial number, PIN and random key code retrieved from memory device 220. The encryption device 230 delivers the encrypted signal to the protocol construction device 235. The protocol construction device 235 constructs the transmission message 760 of FIG. 7 consisting of the unencrypted and encrypted version of the same keystroke and transfers it to the transmission device 240 for transmission. This message is received by the receiver 250 and transferred to the protocol extraction device 255 where it is de-multiplexed. The unencrypted and encrypted payload is transferred to the decryption device 260 where the encrypted component is decrypted using the serial number, PIN and random key code shared secret ciphers retrieved from the shared secret memory 270. If the unencrypted and decrypted values match the keystroke is transferred to the signal interpretation device 275 and a command invocation signal is forwarded to the slave computing device 135 for further processing.

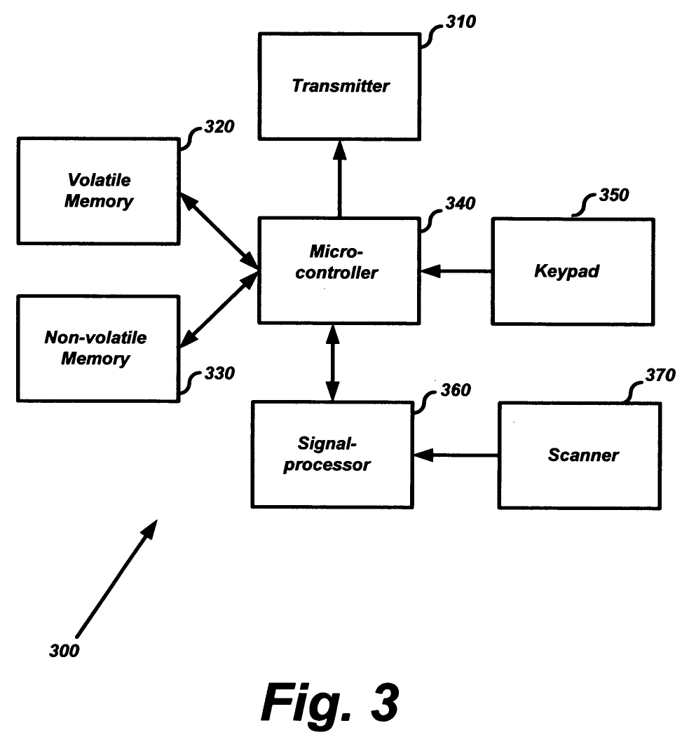

FIG. 3 shows a block diagram of the functional components of the biometric characteristic-enabled remote control device 100 depicted in FIG. 1. The device 300 shown in FIG. 3 is comprised of a central processor (microcontroller 340) coupled to both a volatile memory array 320 and non-volatile memory array 330. The central microcontroller 340 is also coupled to a keypad 350, a transmitter 310 for sending signals to the slave computing device 135, and a signal processor 360 which is dedicated to processing signals from a biometric characteristic scanner 370.

The microcontroller 340 reads program instructions from stored memory 330, thereby giving the remote control device 100 its functionality, which includes the ability to read keystrokes from the keypad 350. All keystrokes entered at the keypad 350 are communicated to the microcontroller 340 and from there communicated to the transmitter 310, either unencrypted or encrypted as appropriate and described later in this document, for transmission to the slave computing device 135.

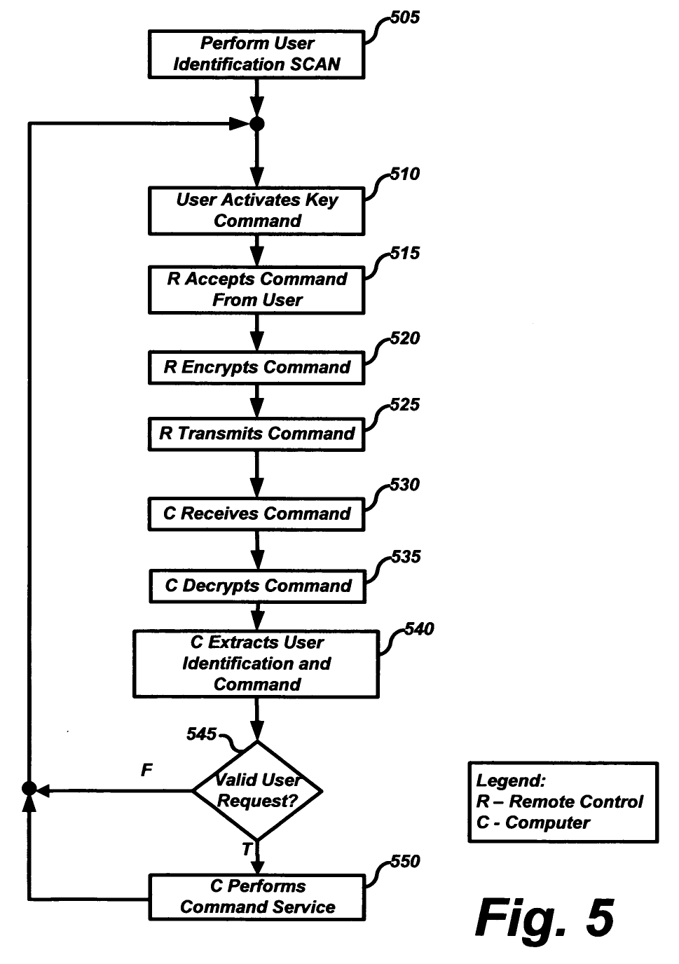

The program instructions retained by the non-volatile memory 330 include program code for the execution a process for registration of a user and the operational process of FIG. 5. Refer now to FIG. 4 for a discussion of the user registration process with reference to the components of the one-way communication remote control device of FIG. 1. A previously-authorized user of the slave computing device 135, in possession of a PIN supplied by the computing device 150, begins by pressing the Registration button (Box 405) from among remote control device's 100 control buttons 105. The unencrypted keystroke is forwarded (Box 410) to the slave computing device 135. The slave computing device 135 displays a numbered list of users (Box 415) and prompts the user to key in the user number (Box 420) from this list. The remote control device 100 then transmits (Box 425) the keyed-in user number encrypted using the remote control device 100 serial number as a shared secret cipher. Use of the serial number as a shared secret cipher ensures that the transmission came from a specific remote control device and not a similar device that someone is using to try and impersonate an authorized user of the slave computing device 135. The computing device then prompts (Box 430) the remote control device 100 user to enter the user PIN using the keypad 110. The remote control device 100 user enters (Box 435) the PIN and the keystrokes are forwarded (Box 440) in encrypted fashion to the slave computing device 135 using the remote control device 100 serial number as the shared secret cipher. The slave computing device 135 verifies the PIN (Box 445) to ensure it was entered correctly.

If the PIN matches (Box 445) that of the PIN associated with the remote control device 100 user, the slave computing device 135 prompts (Box 455) the remote control device 100 user to scan the user's biometric characteristic using scanner 120. If the PIN does not match the slave computing device 135 prompts the remote control device 100 user to start the process over again (Box 450). Provided a match is found, the remote control device 100 user scans the user's biometric characteristic 460. The biometric characteristic is then associated with the user number (Box 420). The remote control device 100 then transmits (Box 470) an encrypted OK keystroke using both the remote control device 100 serial number and user PIN as the shared secret cipher. The computing device 150 decrypts the signal and records (Box 475) that the OK signal received came only from the remote control device 100 and was encrypted with the current device 100 user PIN. Use of the remote control device 100 serial number and user PIN as the shared secret cipher for this transmission ensure that the user being authorized is well-known to the slave computing device 135 and is using a well-known remote control device 100.

FIG. 5 illustrates the operational process for communicating authenticated user commands from the remote control device 100 to the slave computing device 135. A user's biometric characteristic is scanned (Box 505) to identify a user authorized use of the remote control device 100. After a biometric scan recognizes the person performing the scan as an authorized user of the remote control device 100 the user is able to use all keys on the remote control device 100 keypad to elicit services from the slave computing device 135 controlled by the remote control device 100. The user activates a key (Box 510) on the remote control device 100 and the key command is accepted and interpreted (Box 515) by the remote control device 100. The key command is encrypted 520 using the remote control device 100 serial number, the user PIN and the unique dynamic key as shared secret cipher and both the keystroke and its encrypted version 760 of FIG. 7 are transmitted (Box 525) to the slave computing device 135. The slave computing device 135 receives (Box 530) the command and decrypts (Box 535) the encrypted part using the same shared secret ciphers. If decryption succeeds, the slave computing device 135 has verified that the keystroke was transmitted from a known remote control device 100 being used by a person authorized to use the slave computing device 135. The slave computing device 135 extracts user identification and command (Box 540). If the keystroke indicates a service the user is authorized to receive (Box 545) then the slave computing device 135 performs the service (Box 550).

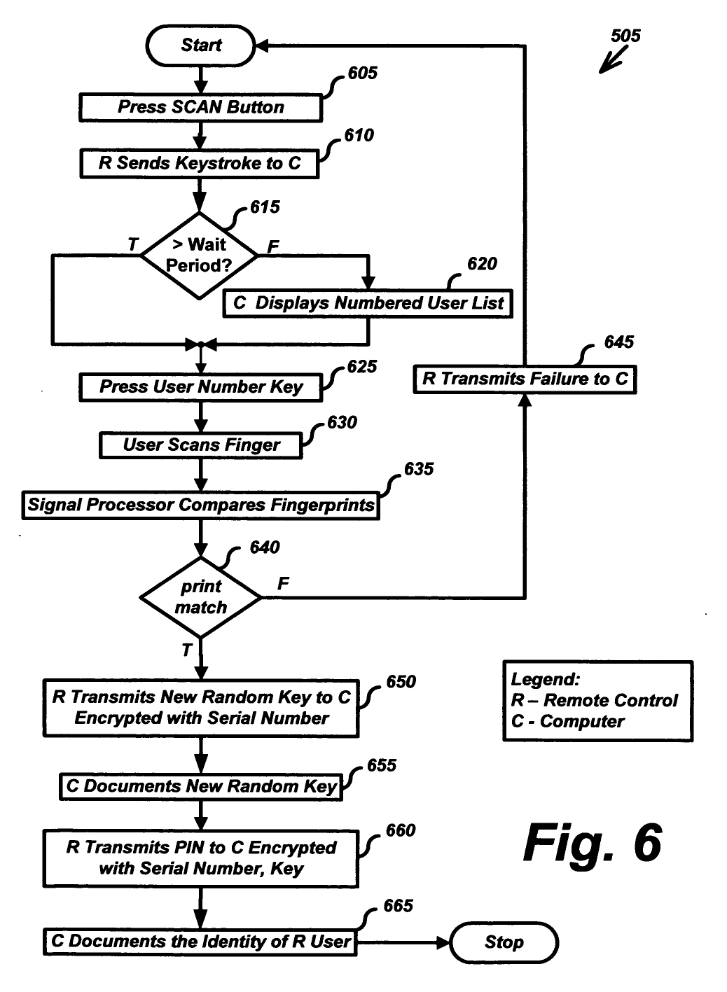

The process of scanning and verification (Box 505 of FIG. 5) of the user's identity is described in FIG. 6 with reference to FIG. 1. The user of the remote control device 100, presses (Box 605) a SCAN key (one of the control keys 105) that initiates the process. This keystroke is communicated (Box 610) to the slave computing device 135. In response, the computer waits for a period of time (i.e. three seconds) (Box 615) and if it does not receive any additional unencrypted keystrokes from the numeric keypad 120, the slave computing device 135 displays on the display unit 160 a numbered list of authorized users of the slave computing device 135 who are also registered as users of the remote control device 100. If the user of the remote control device 100 knows the user number it is keyed in at any time before the period of time (the three second period) expires and the slave computing device 135 will skip the display (Box 620). In either event, the remote control device 100 user enters the user number (Box 625) and this keystroke is saved in the remote control device 100. The remote control device 100 user then scans (Box 630) the user's biometric characteristic. This biometric characteristic is compared (Box 635) to the saved 465 biometric characteristic of the remote control device 100 user identified by the keystroke (Box 625). It is then determined if the biometric characteristic matches the saved 465 biometric characteristic (Box 640). If they do not match, an unencrypted failure code is transmitted (Box 645) to the slave computing device 135 by the remote control device 100. If they do match then the difference between the original saved biometric characteristic of the user and recently scanned (Box 630) biometric characteristic is calculated and this unique error difference is used as a random key for future encryption. This random key is transmitted (Box 650) to the slave computing device 135 by the remote control device 100. The slave computing device 135 documents the new random key (Box 655) This transmission (Box 660) is encrypted using the remote control device 100 serial number as shared secret cipher. Using the same algorithm as that used by the remote control device 100 and described earlier in this document, the slave computing device 135 decrypts the signal and saves the new random key to document the identity of the remote user (Box 665) for future use.

FIGS. 7a and 7b describe the signals transmitted from the remote control device 100 to the slave computing device 135. During the process of initial biometric scan of a user biometric characteristic the user number is transmitted encrypted using the remote control device 100 serial number as the shared secret cipher 710. The user PIN is also transmitted encrypted using the remote control device 100 serial number as the shared secret cipher 720. Upon a successful initial biometric scan and registration process using the remote control device 100, the registration confirmation code is transmitted encrypted using the remote control device 100 serial number and user PIN as the shared secret cipher 730.

During the process of user authentication, the dynamic key code is transmitted using the remote control device 100 serial number as the shared secret cipher 740. The user PIN is transmitted 750 encrypted using the dynamic key and remote control device 100 serial number as shared secret ciphers. Finally, once a user has been authenticated, additional keystrokes are transmitted 770 in both unencrypted and encrypted form. The encryption is performed using the remote control device 100 serial number, the user PIN and the dynamic key code as shared secret ciphers.

While this invention has been particularly shown and described with reference to the preferred embodiments thereof, it will be understood by those skilled in the art that various changes in form and details may be made without departing from the spirit and scope of the invention.

The invention claimed is:

1. A one-way communication apparatus for communicating with a slave computing device for invoking services provided by said slave computing device, said one-way communication apparatus comprising:
a shared secret data retention device to retain a shared identifying cipher associated uniquely with said one-way communication apparatus and retained within said slave computing device and known only to said one-way communication apparatus and said slave computing device;
a dynamic key generation device for generating a dynamic non-reusable key;
a user authentication device connected to receive a current user identification data for generating a user verification code that said user is authorized to communicate with said slave computing device;
an encryption device connected to receive a command instruction code, said command instruction code indicating a service to be invoked on said slave computing system, and connected to said shared secret retention device to extract said shared identifying cipher, said dynamic key generation device to receive said dynamic non-reusable key, and said user authentication device to receive said user verification code and if said user verification code indicates that said user is a known user of said one-way communication apparatus, encrypting said command instruction code, said shared identifying cipher, and said dynamic non-reusable key together to form a authenticated command message that is transmitted to said slave computing device to invoke said services provided by said slave computing device.

2. The one-way communication apparatus of claim 1 wherein said user identification data is a biometric identification data selected from the group of biometric data consisting of fingerprint data, face recognition scan data, voice print data, and unique physical biometric data.

3. The one-way communication apparatus of claim 1 further comprising:
a first memory device retaining an original user identification data captured during a registration of said user on said one-way communication apparatus,
wherein said user authentication device receives said current user identification data and in communication with said first memory device to extract said original user identification data for comparing said current user identification data and said original user identification data for verifying said user identification and generating said verification code.

4. The one-way communication apparatus of claim 1 wherein said shared secret cipher comprises a serial number assigned to said one-way communication apparatus and a personal identification number identifying an authorized user of said slave computing system.

5. The one-way communication apparatus of claim 1 wherein said authenticated command message is generated using a message digest algorithm.

6. The one-way communication apparatus of claim 1 wherein authenticated command message is generated using a secure hash algorithm.

7. The one-way communication apparatus of claim 1 wherein said command instruction code is coupled with said authenticated command message and transmitted to said slave computing system.

8. The one-way communication apparatus of claim 1 further comprising:
a key pad comprising an arrangement of key switches wherein when any of said key switches are activated, said key pad generates a key code; and
a command interpretation device in communication with said key pad receives said key code and generates said command instruction code for invoking services provided by said slave computing device.

9. The one-way communication apparatus of claim 1 wherein said dynamic non-reusable key comprises a monotonically increasing key code and a dynamically generated key.

10. The one-way communication apparatus of claim 9 wherein said dynamic key generation device comprises:
a monotonically increasing number generator for creating said monotonically increasing key code and in communication with said encryption device to transfer said monotonically increasing key code to said encryption device.
a dynamic key calculating device connected to said user authentication device to receive a unique error as a function of said current user identification data.

11. The one-way communication apparatus of claim 1 wherein said dynamic non-reusable key is a timestamp code indicating an initiation time for a session of a plurality of authenticated command messages.

12. The one-way communication apparatus of claim 11 further comprising a timer device that generates said timestamp code and is in communication with said encryption device to transfer said timestamp code to said encryption device as said dynamic non-reusable key.

13. The one-way communication apparatus of claim 1 further comprising:
protocol construction device in communication with said encryption device to receive said authenticated command message and to append a synchronization signal and error code to said authenticated command message to generate a transmission message; and
a transmitter for transmitting said transmission message to said slave computing system to invoke said services provided by said slave computing device.

14. The one-way communication apparatus of claim 4 wherein said one-way communication apparatus registers a user as an authorized user of said one-way communication apparatus by the steps of:
placing said serial number permanently in said shared secret data retention device by a manufacturer;
transferring a register command to said encryption device
communicating from said slave computing system to said user a user identification number;
communicating said user identification number by said user to said encryption device;
encrypting by said encryption device said user identification number with said serial number to generate an encrypted user code;
transferring said encrypted user code to said slave computing system;
requesting by said slave computing system said personal identification number from said user;
communicating said personal identification number to said encryption device and said shared secret data retention device;
encrypting said personal identification number with said serial number to generate an encrypted shared identifying cipher;
transferring said encrypted shared identifying cipher to said slave computing system for verification;
if said encrypted shared identifying cipher is verified, communicating by said user an original user identification data that is compared with said current user identification data to generate user verification code;
encrypting said shared identifying cipher with an approval code to generate an encrypted approval code;
transferring by said one-way communication apparatus an encrypted approval code to said slave computing system; and
registering said user as authorized to use said one-way communication apparatus to invoke said services provided by said slave computing device.

15. The one-way communication apparatus of claim 1 wherein said user invokes said services provided by said slave computing device by the steps of:
providing by said user a user identification number;
generating said current user identification data;
comparing said original user identification data to said current user identification data to verify that said user is authorized to use said one-way communication apparatus;
encrypting said dynamic non-reusable key with said shared identifying cipher to generate an dynamic non-reusable key code; and
communicating said encrypted dynamic non-reusable key code to said slave computing system.

16. The one-way communication apparatus of claim 15 wherein said user further invokes said services provided by said slave computing device by the steps of:
receiving by said one-way communication apparatus said command instruction code from said user;
encrypting said command instruction code with shared identifying cipher and said dynamic non-reusable key to generate said authenticated command message;
communicating said authenticated command message to said slave computing device;
decrypting said authenticated command message by said slave computing device to extract said command instruction code; and
invoking by said slave computing device said services provided and authorized by said slave computing device.

17. The one-way communication apparatus of claim 1 wherein said services are selected from the set of computer services consisting of voice and video telephone services, voice and video conferencing services, email services, and controlling computing functional services of said slave computing device.

18. A one-way communication system for communicating from a remote location to a slave computing system for communicating from said remote location authenticated command messages for invoking services provided by said slave computing device, said one-way communication system comprising:
a one-way communication apparatus comprising:
a shared secret data retention device to retain a shared identifying cipher associated uniquely with said one-way communication apparatus and retained within said slave computing device and known only to said one-way communication apparatus and said slave computing device;
a dynamic key generation device for generating a dynamic non-reusable key;
a user authentication device connected to receive a current user identification data for generating a user verification code that said user is authorized to communicate with said slave computing device;
an encryption device connected to receive a command instruction code, said command instruction code indicating a service to be invoked on said slave computing system, and connected to said shared secret retention device to extract said shared identifying cipher, said dynamic key generation device to receive said dynamic non-reusable key, and said user authentication device to receive said user verification code and if said user verification code indicates that said user is a known user of said one-way communication apparatus, encrypting said command instruction code, said shared identifying cipher, and said dynamic non-reusable key together to form a authenticated command message that is transmitted to said slave computing device to invoke said services provided by said slave computing device; and
a receiving device in communication with said slave computing device and said one-way communication apparatus for receiving a transmission message including said authenticated command message and decrypting said authenticated command message to develop a command invocation code to invoke said services provided by said slave computing device.

19. The one-way communication system of claim 18 wherein said one-way communication apparatus further comprises:
a first memory device retaining an original user identification data captured during a registration of said user on said one-way communication apparatus,
wherein said user authentication device receives said current user identification data and in communication with said first memory device to extract said original user identification data for comparing said current user identification data and said original user identification data for verifying said user identification and generating said verification code.

20. The one-way communication system of claim 18 wherein said shared secret cipher comprises a serial number assigned to said one-way communication apparatus and a personal identification number identifying an authorized user of said slave computing system.

21. The one-way communication system of claim 18 wherein said authenticated command message is generated using a message digest algorithm.

22. The one-way communication system of claim 18 wherein authenticated command message is generated using a secure hash algorithm.

23. The one-way communication system of claim 18 wherein said command instruction code is coupled with said authenticated command message and transmitted to said slave computing system.

24. The one-way communication system of claim 18 wherein said one-way communication apparatus further comprises:
a key pad comprising an arrangement of key switches wherein when any of said key switches are activated, said key pad generates a key code; and
a command interpretation device in communication with said key pad receives said key code and generates said command instruction code for invoking services provided by said slave computing device.

25. The one-way communication system of claim 18 wherein said dynamic non-reusable key comprises a monotonically increasing key code and a dynamically generated key.

26. The one-way communication system of claim 25 wherein said dynamic key generation device comprises:
a monotonically increasing number generator for creating said monotonically increasing key code and in communication with said encryption device to transfer said monotonically increasing key code to said encryption device.
a dynamic key calculating device connected to said user authentication device to receive a unique error as a function of said current user identification data.

27. The one-way communication system of claim 18 wherein said dynamic non-reusable key is a timestamp code indicating an initiation time for a session of a plurality of authenticated command messages.

28. The one-way communication system of claim 27 wherein said one-way communication apparatus further comprises a timer device that generates said timestamp code and is in communication with said encryption device to transfer said timestamp code to said encryption device as said dynamic non-reusable key.

29. The one-way communication system of claim 18 wherein one-way communication apparatus further comprises:
protocol construction device in communication with said encryption device to receive said authenticated command message and to append a synchronization signal and error code to said authenticated command message to generate said transmission message; and
a transmitter for transmitting said transmission message to said slave computing system to invoke said services provided by said slave computing device.

30. The one-way communication system of claim 21 wherein said one-way communication apparatus registers a user as an authorized user of said one-way communication apparatus by the steps of:
placing said serial number permanently in said shared secret data retention device by a manufacturer;
transferring a register command to said encryption device
communicating from said slave computing system to said user a user identification number;
communicating said user identification number by said user to said encryption device;
encrypting by said encryption device said user identification number with said serial number to generate an encrypted user code;
transferring said encrypted user code to said slave computing system;
requesting by said slave computing system said personal identification number from said user;
communicating said personal identification number to said encryption device and said shared secret data retention device;
encrypting said personal identification number with said serial number to generate an encrypted shared identifying cipher;
transferring said encrypted shared identifying cipher to said slave computing system for verification;
if said encrypted shared identifying cipher is verified, communicating by said user an original user identification data that is compared with said current user identification data to generate user verification code;
encrypting said shared identifying cipher with an approval code to generate an encrypted approval code;
transferring by said one-way communication apparatus an encrypted approval code to said slave computing system; and
registering said user as authorized to use said one-way communication apparatus to invoke said services provided by said slave computing device.

31. The one-way communication system of claim 18 wherein said user invokes said services provided by said slave computing device by the steps of:
providing by said user a user identification number;
generating said current user identification data;
comparing said original user identification data to said current user identification data to verify that said user is authorized to use said one-way communication apparatus;
encrypting said dynamic non-reusable key with said shared identifying cipher to generate a dynamic non-reusable key code; and
communicating said encrypted dynamic non-reusable key code to said slave computing system.

32. The one-way communication system of claim 31 wherein said user further invokes said services provided by said slave computing device by the steps of:
receiving by said one-way communication apparatus said command instruction code from said user;
encrypting said command instruction code with shared identifying cipher and said dynamic non-reusable key to generate said authenticated command message;
communicating said authenticated command message to said slave computing device;
decrypting said authenticated command message by said slave computing device to extract said command instruction code; and
invoking by said slave computing device said services provided and authorized by said slave computing device.

33. The one-way communication system of claim 18 wherein said services are selected from the set of computer services consisting of voice and video telephone services, voice and video conferencing services, email services, and controlling computing functional services of said slave computing device.

34. The one-way communication system of claim 18 where in said receiving device comprises:
a reception device for acquiring and conditioning said transmission message;
a protocol extraction device in communication with said reception device to receive said transmission message and extract said authenticated command message
a decryption device in communication with said protocol extraction device to receive said authenticated command message to extract said command instruction code, shared identifying cipher, and said dynamic non-reusable key;
a user verification device in communication with said decryption device to receive said command instruction code, shared identifying cipher, and said dynamic non-reusable key and compare shared identifying cipher, and said dynamic non-reusable key with a retained copy of said shared identifying cipher, and said dynamic non-reusable key to verify that said command instruction code is from an authorized user and to generate a verified user code; and
a signal interpretation device in communication with said user verification device to receive said verified user code and said command instruction code such that if said verified user code indicates that said user is authorized, said signal interpretation device forwards said command instruction code to said slave computing device to invoke said services provided by said slave computing device.

35. The one-way communication system of claim 34 wherein said signal interpretation device is communication with said protocol extraction device to receive an un-encrypted command instruction code and in turn forwards said un-encrypted command instruction code to said slave computing system for execution if said verified user code indicates that said user is authorized.

36. The one-way communication system of claim 34 wherein said user verification device receives a user permission code for determining if an authorized user is permitted to invoke said services provided by said slave computing device and setting said verified user code whether said authorized user has permission for invoking said services from said slave computing device.

37. A method for communicating from a remote control device to a slave computing system using authenticated command messages for invoking services provided by said slave computing device, said method comprising the steps of:
transmitting by way of a one-way communication path an authenticated command message by the steps of:
retaining in a shared secret data retention device a shared identifying cipher associated uniquely with said remote control device,
retaining within said slave computing device said shared identifying cipher such that said shared identifying cipher is known only to said remote control device and said slave computing device,
generating a dynamic non-reusable key,
generating a user verification code that said user is authorized to communicate with said slave computing device from a current user identification data,
receiving a command instruction code indicating a service to be invoked on said slave computing system,
if said user verification code indicates that said user is a known user of said remote control device, encrypting said command instruction code, said shared identifying cipher, and said dynamic non-reusable key together to form said authenticated command message, and
transmitting said authenticated command message to said slave computing device to invoke said services provided by said slave computing device; and
receiving a transmission message including said authenticated command message; and
decrypting said authenticated command message to develop a command invocation code to invoke said services provided by said slave computing device.

38. The method for communicating from a remote control device to a slave computing system of claim 37 further comprising the steps of:
retaining an original user identification data captured during a registration of said user on said remote control device in a first memory device;
receiving said current user identification data;
extracting said original user identification data from said first memory device; and
comparing said current user identification data and said original user identification data for verifying said user identification and generating said verification code.

39. The method for communicating from a remote control device to a slave computing system of claim 37 wherein said shared secret cipher comprises a serial number assigned to said one-way communication apparatus and a personal identification number identifying an authorized user of said slave computing system.

40. The method for communicating from a remote control device to a slave computing system of claim 37 wherein encrypting said command instruction code employs a message digest algorithm.

41. The method for communicating from a remote control device to a slave computing system of claim 37 wherein encrypting said command instruction code employs a secure hash algorithm.

42. The method for communicating from a remote control device to a slave computing system of claim 37 wherein said command instruction code is coupled with said authenticated command message.

43. The method for communicating from a remote control device to a slave computing system of claim 37 further comprising the steps of:
generating a key code by activating any of an arrangement of key switches of a key pad; and
generating said command instruction code for invoking services provided by said slave computing device from said key code.

44. The method for communicating from a remote control device to a slave computing system of claim 37 wherein said dynamic non-reusable key comprises a monotonically increasing key code and a dynamically generated key.

45. The method for communicating from a remote control device to a slave computing system of claim 44 wherein generating a dynamic non-reusable key comprises the steps of:
creating said monotonically increasing key code and in communication with said encryption device to transfer said monotonically increasing key code to said encryption device; and
generating said dynamically non-reusable key as a unique error that is a function of said current user identification data.

46. The method for communicating from a remote control device to a slave computing system of claim 37 wherein generating said dynamic non-reusable key comprises the step of creating a timestamp code indicating an initiation time for a session of a plurality of authenticated command messages ask said dynamic non-reusable key.

47. The method for communicating from a remote control device to a slave computing system of claim 37 further comprising the step of:
constructing said transmission message from said authenticated command message by appending a synchronization signal and error code to said authenticated command message.

48. The method for communicating from a remote control device to a slave computing system of claim 40 further comprising the step of registering a user as an authorized user of said one-way communication apparatus by the steps of:
placing said serial number permanently in said shared secret data retention device by a manufacturer;
transferring a register command to said encryption device
communicating from said slave computing system to said user a user identification number;
communicating said user identification number by said user to said encryption device;
encrypting by said encryption device said user identification number with said serial number to generate an encrypted user code;
transferring said encrypted user code to said slave computing system;
requesting by said slave computing system said personal identification number from said user;
communicating said personal identification number to said encryption device and said shared secret data retention device;
encrypting said personal identification number with said serial number to generate an encrypted shared identifying cipher;
transferring said encrypted shared identifying cipher to said slave computing system for verification;
if said encrypted shared identifying cipher is verified, communicating by said user an original user identification data that is compared with said current user identification data to generate user verification code;
encrypting said shared identifying cipher with an approval code to generate an encrypted approval code;
transferring by said one-way communication apparatus an encrypted approval code to said slave computing system; and
registering said user as authorized to use said one-way communication apparatus to invoke said services provided by said slave computing device.

49. The method for communicating from a remote control device to a slave computing system of claim 37 further comprises the step of invoking said services provided by said slave computing device by the steps of:
providing by said user a user identification number;
generating said current user identification data;
comparing said original user identification data to said current user identification data to verify that said user is authorized to use said one-way communication apparatus;
encrypting said dynamic non-reusable key with said shared identifying cipher to generate a dynamic non-reusable key code; and
communicating said encrypted dynamic non-reusable key code to said slave computing system.

50. The method for communicating from a remote control device to a slave computing system of claim 49 wherein invoking said services provided by said slave computing device further comprises the steps of:
receiving by said one-way communication apparatus said command instruction code from said user;
encrypting said command instruction code with shared identifying cipher and said dynamic non-reusable key to generate said authenticated command message;
communicating said authenticated command message to said slave computing device;
decrypting said authenticated command message by said slave computing device to extract said command instruction code; and
invoking by said slave computing device said services provided and authorized by said slave computing device.

51. The method for communicating from a remote control device to a slave computing system of claim 37 wherein said services are selected from the set of computer services consisting of voice and video telephone services, voice and video conferencing services, email services, and controlling computing functional services of said slave computing device.

52. The method for communicating from a remote control device to a slave computing system of claim 37 wherein decrypting said authenticated command message comprises the step of extracting said command instruction code, shared identifying cipher, and said dynamic non-reusable key.

53. The method for communicating from a remote control device to a slave computing system of claim 37 wherein receiving a transmission message comprises the steps of:
acquiring and conditioning said transmission message;
extracting said authenticated command message;

54. The method for communicating from a remote control device to a slave computing system of claim 37 further comprising the steps of:
comparing said shared identifying cipher, and said dynamic non-reusable key with a retained copy of said shared identifying cipher, and said dynamic non-reusable key
verifying that said command instruction code is from an authorized user;
generating a verified user code; and
if said verified user code indicates that said user is authorized, forwarding said command instruction code to said slave computing device to invoke said services provided by said slave computing device.

55. The method for communicating from a remote control device to a slave computing system of claim 37 further comprising the steps of”:
receiving an un-encrypted command instruction code; and
forwarding said un-encrypted command instruction code to said slave computing system for execution if said verified user code indicates that said user is authorized.

56. The method for communicating from a remote control device to a slave computing system of claim 37 further comprising the steps of
receiving a user permission code for determining if an authorized user is permitted to invoke said services provided by said slave computing device; and
setting said verified user code whether said authorized user has permission for invoking said services from said slave computing device.

57. A computer readable medium containing program instruction code readable by and executable on a computing system which, when executed on the computing system comprising a remote control and a slave computing system, performs a computer program process for communicating from said remote control device to said slave computing system using authenticated command messages for invoking services provided by said slave computing device, said program process comprising the steps of:
transmitting by way of a one-way communication path an authenticated command message by the steps of:
retaining in a shared secret data retention device a shared identifying cipher associated uniquely with said remote control device,
retaining within said slave computing device said shared identifying cipher such that said shared identifying cipher is known only to said remote control device and said slave computing device,
generating a dynamic non-reusable key,
generating a user verification code that said user is authorized to communicate with said slave computing device from a current user identification data,
receiving a command instruction code indicating a service to be invoked on said slave computing system,
if said user verification code indicates that said user is a known user of said remote control device, encrypting said command instruction code, said shared identifying cipher, and said dynamic non-reusable key together to form said authenticated command message, and
transmitting said authenticated command message to said slave computing device to invoke said services provided by said slave computing device; and
receiving a transmission message including said authenticated command message; and
decrypting said authenticated command message to develop a command invocation code to invoke said services provided by said slave computing device.

58. The computer readable medium containing program instruction code of claim 57 wherein said program process further comprises the steps of:
retaining an original user identification data captured during a registration of said user on said remote control device in a first memory device;
receiving said current user identification data;
extracting said original user identification data from said first memory device; and
comparing said current user identification data and said original user identification data for verifying said user identification and generating said verification code.

59. The computer readable medium containing program instruction code of claim 57 wherein said shared secret cipher comprises a serial number assigned to said one-way communication apparatus and a personal identification number identifying an authorized user of said slave computing system.

60. The computer readable medium containing program instruction code of claim 57 wherein encrypting said command instruction code employs a message digest algorithm.

61. The computer readable medium containing program instruction code of claim 57 wherein encrypting said command instruction code employs a secure hash algorithm.

62. The computer readable medium containing program instruction code of claim 57 wherein said command instruction code is coupled with said authenticated command message.

63. The computer readable medium containing program instruction code of claim 57 wherein said program process further comprises the steps of:
generating a key code by activating any of an arrangement of key switches of a key pad; and
generating said command instruction code for invoking services provided by said slave computing device from said key code.

64. The computer readable medium containing program instruction code of claim 57 wherein said dynamic non-reusable key comprises a monotonically increasing key code and a dynamically generated key.

65. The computer readable medium containing program instruction code of claim 64 wherein generating a dynamic non-reusable key comprises the steps of:
creating said monotonically increasing key code and in communication with said encryption device to transfer said monotonically increasing key code to said encryption device; and
generating said dynamically non-reusable key as a unique error that is a function of said current user identification data.

66. The computer readable medium containing program instruction code of claim 57 wherein generating said dynamic non-reusable key comprises the step of creating a timestamp code indicating an initiation time for a session of a plurality of authenticated command messages ask said dynamic non-reusable key.

67. The computer readable medium containing program instruction code of claim 57 wherein said program process further comprises the step of:
constructing said transmission message from said authenticated command message by appending a synchronization signal and error code to said authenticated command message.

68. The computer readable medium containing program instruction code of claim 61 wherein said program process further comprises the step of registering a user as an authorized user of said one-way communication apparatus by the steps of:
placing said serial number permanently in said shared secret data retention device by a manufacturer;
transferring a register command to said encryption device
communicating from said slave computing system to said user a user identification number;
communicating said user identification number by said user to said encryption device;
encrypting by said encryption device said user identification number with said serial number to generate an encrypted user code;
transferring said encrypted user code to said slave computing system;
requesting by said slave computing system said personal identification number from said user;
communicating said personal identification number to said encryption device and said shared secret data retention device;
encrypting said personal identification number with said serial number to generate an encrypted shared identifying cipher;
transferring said encrypted shared identifying cipher to said slave computing system for verification;
if said encrypted shared identifying cipher is verified, communicating by said user an original user identification data that is compared with said current user identification data to generate user verification code;
encrypting said shared identifying cipher with an approval code to generate an encrypted approval code;
transferring by said one-way communication apparatus an encrypted approval code to said slave computing system; and
registering said user as authorized to use said one-way communication apparatus to invoke said services provided by said slave computing device.

69. The computer readable medium containing program instruction code of claim 57 wherein said program process further comprises the step of invoking said services provided by said slave computing device by the steps of:
providing by said user a user identification number;
generating said current user identification data;
comparing said original user identification data to said current user identification data to verify that said user is authorized to use said one-way communication apparatus;
encrypting said dynamic non-reusable key with said shared identifying cipher to generate a dynamic non-reusable key code; and
communicating said encrypted dynamic non-reusable key code to said slave computing system.

70. The computer readable medium containing program instruction code of claim 69 wherein invoking said services provided by said slave computing device further comprises the steps of:
receiving by said one-way communication apparatus said command instruction code from said user;
encrypting said command instruction code with shared identifying cipher and said dynamic non-reusable key to generate said authenticated command message;
communicating said authenticated command message to said slave computing device;
decrypting said authenticated command message by said slave computing device to extract said command instruction code; and
invoking by said slave computing device said services provided and authorized by said slave computing device.

71. The computer readable medium containing program instruction code of claim 57 wherein said services are selected from the set of computer services consisting of voice and video telephone services, voice and video conferencing services, email services, and controlling computing functional services of said slave computing device.

72. The computer readable medium containing program instruction code of claim 57 wherein decrypting said authenticated command message comprises the step of extracting said command instruction code, shared identifying cipher, and said dynamic non-reusable key.

73. The computer readable medium containing program instruction code of claim 57 wherein receiving a transmission message comprises the steps of:
acquiring and conditioning said transmission message;
extracting said authenticated command message;

74. The computer readable medium containing program instruction code of claim 57 wherein said program process further comprises the steps of:
comparing said shared identifying cipher, and said dynamic non-reusable key with a retained copy of said shared identifying cipher, and said dynamic non-reusable key
verifying that said command instruction code is from an authorized user;
generating a verified user code; and
if said verified user code indicates that said user is authorized, forwarding said command instruction code to said slave computing device to invoke said services provided by said slave computing device.

75. The computer readable medium containing program instruction code of claim 57 wherein said program process further comprises the steps of”:
receiving an un-encrypted command instruction code; and
forwarding said un-encrypted command instruction code to said slave computing system for execution if said verified user code indicates that said user is authorized.

76. The computer readable medium containing program instruction code of claim 57 wherein said program process further comprises the steps of
receiving a user permission code for determining if an authorized user is permitted to invoke said services provided by said slave computing device; and
setting said verified user code whether said authorized user has permission for invoking said services from said slave computing device.
